(19) United States
(12) Patent Application Publication
(10) Pub. No.: US 2019/0228313 A1
(43) Pub. Date: Jul. 25, 2019

(54) Computer Vision Systems and Methods for Unsupervised Representation Learning by Sorting Sequences

(71) Applicant: Insurance Services Office, Inc., Jersey City, NJ (US)

(72) Inventors: Hsin-Ying Lee, Merced, CA (US); Jia-Bin Huang, Blacksburg, VA (US); Maneesh Kumar Singh, Lawrenceville, NJ (US); Ming-Hsuan Yang, Sunnyvale, CA (US)

(73) Assignee: Insurance Services Office, Inc., Jersey City, NJ (US)

(21) Appl. No.: 16/255,422

(22) Filed: Jan. 23, 2019

Related U.S. Application Data
(60) Provisional application No. 62/620,700, filed on Jan. 23, 2018.

(51) Int. Cl. G06N 3/08; G06F 7/08; G06T 7/20

(52) U.S. Cl. CPC G06N 3/088; G06T 7/20; G06F 7/08

(57) ABSTRACT

Systems and methods for unsupervised representation learning by sorting sequences are provided. An unsupervised representation learning approach is provided which uses videos without semantic labels. The temporal coherence as a supervisory signal can be leveraged by formulating representation learning as a sequence sorting task. A plurality of temporally shuffled frames (i.e., in non-chronological order) can be used as inputs and a convolutional neural network can be trained to sort the shuffled sequences and to facilitate machine learning of features by the convolutional neural network. Features are extracted from all frame pairs and aggregated to predict the correct sequence order. As sorting shuffled image sequence requires an understanding of the statistical temporal structure of images, training with such a proxy task can allow a computer to learn rich and generalizable visual representations from digital images.

### CROSS-REFERENCE TO RELATED APPLICATIONS

This application claims the benefit of U.S. Provisional Patent Application No. 62/620,700 filed on Jan. 23, 2018, the entire disclosure of which is expressly incorporated herein by reference.

### BACKGROUND

### Technical Field

The present disclosure relates generally to the field of computer vision. More particularly, the present disclosure relates to computer vision systems and methods for unsupervised representation learning by sorting sequences.

### Related Art

Convolutional Neural Networks (CNNs) have been used in visual recognition tasks involving millions of manually annotated data of images. While CNNs have shown dominant performance in high-level recognition problems such as classification and detection, training a deep network often requires processing millions of manually-labeled images. In addition to being time-consuming and inefficient, this approach substantially limits the scalability of CNNs to new problem domains because manual annotations are often expensive and, in some cases, scarce (e.g., labeling medical images requires significant expertise on the part of humans, such as healthcare professionals).

The inherent limitation from the fully supervised training paradigm highlights the importance of unsupervised learning to leverage vast amounts of unlabeled data. A vast amount of free unlabeled images and videos are readily available. Before the resurgence of CNNs, hand-craft features have been used to discover semantic classes using clustering, or mining discriminative mid-level features. With deep learning techniques, rich visual representations can be learned and extracted directly from images. Some systems focuses on reconstruction-based learning. Inspired from the original single-layer auto-encoders, several variants have been developed, including stack layer-by-layer restricted Boltzmann machines (RBMs), and auto encoders.

Some solutions attempt to leverage the inherent structure of raw images and formulate a discriminative or reconstruction loss function to train formulated models. These solutions define a supervisory signal for learning using the structure of the raw visual data. The spatial context in an image provides a rich source of supervision. Accordingly, some solutions include predicting the relative position of patches, reconstructing missing pixel values conditioned on the known surrounding area, predicting one subset of the data channels from another (e.g., predicting color channels from a gray image), solving jigsaw puzzles, in-painting missing regions based on their surroundings, and using cross-channel prediction and split-brain auto-encoders. In addition to using only individual images, some solutions are directed to grouping visual entities using co-occurrence in space and time, using graph-based constraints, and cross-modal supervision from sounds. Compared to image data, videos potentially provide much richer information as they not only consist of large amounts of image samples, but also provide scene dynamics. In comparison to images, videos provide the advantage of having an additional time dimension. Videos provide examples of appearance variations of objects over time.

Therefore, there exists a need for a surrogate task for self-supervised learning using a large collection of unlabeled videos. These and other needs are addressed by the computer vision systems and methods of the present disclosure.

### SUMMARY

Computer vision systems and methods for unsupervised representation learning by sorting sequences are provided. An unsupervised representation learning approach is provided which uses videos without semantic labels. The temporal coherence as a supervisory signal can be leveraged by formulating representation learning as a sequence sorting task. A plurality of temporally shuffled frames (i.e., in non-chronological order) can be used as inputs and a convolutional neural network can be trained to sort the shuffled sequences and to facilitate machine learning of features by the convolutional neural network Similar to comparison-based sorting algorithms, features can be extracted from all frame pairs and aggregated to predict the correct sequence order. As sorting shuffled image sequence requires an understanding of the statistical temporal structure of images, training with such a proxy task can allow a computer to learn rich and generalizable visual representations from digital images.

### BRIEF DESCRIPTION OF THE DRAWINGS

The foregoing features of the present disclosure will be apparent from the following Detailed Description, taken in connection with the accompanying drawings, in which:

FIG. 1 is a flowchart illustrating overall processing steps carried out by the computer vision systems and methods of the present disclosure;

FIG. 2 is a flowchart illustrating processing steps carried out by the system for data sampling;

FIG. 3 is a drawing illustrating a data sampling process carried out by the system on a sample video;

FIG. 4 is a flowchart illustrating processing steps carried out by the system for predicting the order of a randomly shuffled video tuple;

FIG. 5 is a diagram illustrating the overall architecture of the system of the present disclosure;

FIG. 6 is a diagram illustrating a video tuple being sorted by the system of the present disclosure;

FIG. 7 is a drawing showing tuples of unlabeled video frames extracted from a dataset by the system of the present disclosure;

FIG. 8 depicts graphs illustrating the performance of training by the system of the present disclosure of a convolutional neural network with two different datasets;

FIG. 9 is a graph showing the results of the system employing different strategies for learning visual clues from color;

FIG. 10 depicts images showing visualization by the system of learned filters for channel splitting;

FIG. 11 depicts images illustrating learning performed by the system on several “pool5” units on the Pascal VOC 2007 dataset;

FIG. 12 depicts images illustrating different approaches to data sampling capable of being performed by the system;

FIG. 13 depicts images illustrating automatically sampled tuples;

FIG. 14 depicts images illustrating results of various channel selection methods performed by the system, both before and after fine tuning;

FIG. 15 depicts images illustrating a comparison of the “conv1” filters processed by the system after after fine-tuning on the UCF-101 and the VOC dataset;

FIG. 16 depicts images illustrating visualization by the system of the conv1 filters of the 5-tuple OPN; and

FIG. 17 is a diagram illustrating computer hardware and network components on which the present invention could be implemented.

### DETAILED DESCRIPTION

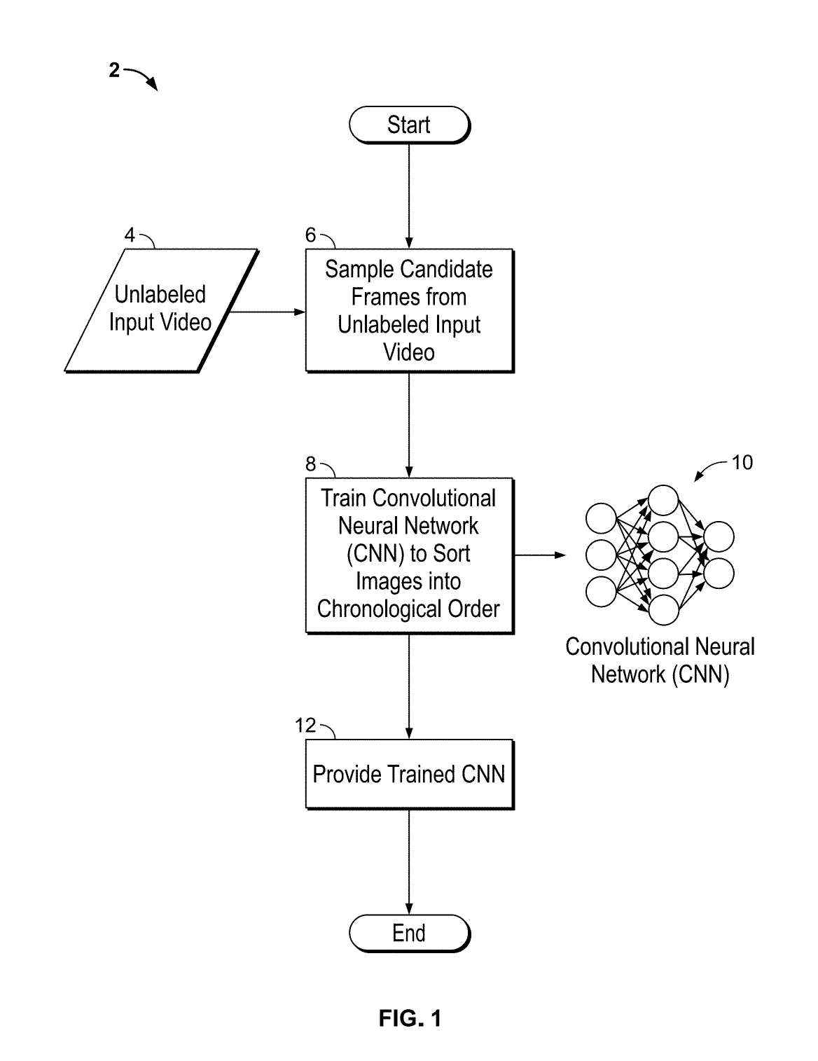

The present disclosure relates to computer vision systems for unsupervised representation learning by sorting sequences, as discussed in detail below in connection with FIGS. 1-17. The system is particularly useful for performing machine visual recognition of objects in videos. In particular, the present disclosure provides a surrogate task for self-supervised learning using a large collection of unlabeled videos. Given a tuple of randomly shuffled frames, a neural network is trained to sort the images into chronological order. Solving the sequence sorting problem provides strong supervisory signals as the system needs to reason and understand the statistical temporal structure of image sequences. In comparison to images, videos provide the advantage of having an additional time dimension. Videos provide examples of appearance variations of objects over time. Successfully solving the sequence sorting task will allow the CNN to learn useful visual representation to recover the temporal coherence of video by observing how objects move in the scene.

FIG. 1 is a flowchart illustrating processing steps 2 for a computer vision system for visual recognition of objects in unlabeled videos. In step 4, unlabeled input video is received by the system. Such input video could be supplied to the system in real time (e.g., from security cameras or other sources), retrieved from a data source (e.g., stored locally or remotely), or from any other suitable source such as the Internet or a cloud-based video source. In step 6, candidate frames from unlabeled input video are sampled by the system. In step 8, a convolutional neural network (CNN) 10 is trained to sort images in chronological order. As described in greater detail below, by training the CNN to sort images in chonological order, such training causes the CNN to learn features in the images that can be used to detect similar features in other images/videos when the CNN is used in the future. In particular, it has been found that causing the CNN to sort images in sequence causes the CNN to learn features in images/videos more rapidly and with significantly less training data and time as is required with other approaches. Finally, in step 12, the convolutional network has been successfully trained, and is provided for future computer vision and image recognition tasks. For example, the trained CNN could be incorporated into another software system and/or computer system for performing vision tasks to identify desired features in videos, to track features in videos, etc.

The present disclosure can use up to four randomly shuffled frames sampled from a video as the input in step 6 discussed above. The sequence sorting problem can be described as a multi-class classification task. For each tuple of four frames, there are 4!=24 possible permutations. However, as some actions are coherent forward and backward (e.g., opening/closing a door), both forward and backward permutations can be grouped into the same class (e.g., 24/2 classes for four frames). This forward-backward grouping is conceptually similar to the commonly used horizontal flipping for images.

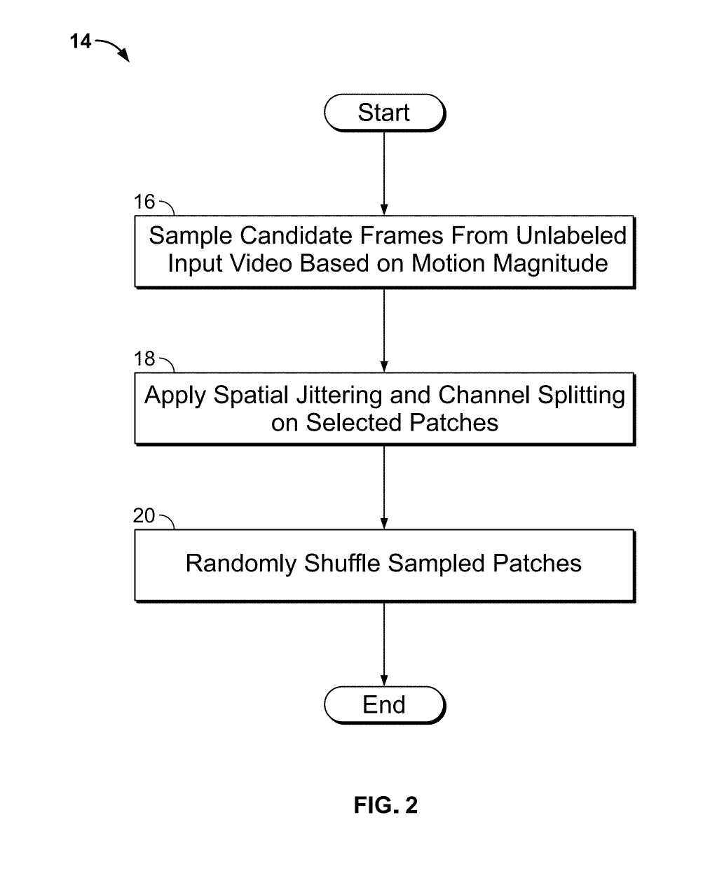

FIG. 2 is a flowchart illustrating, in greater detail, processing step 14 for data sampling as discussed in step 6 of FIG. 1. Preparing training data can improve unsupervised learning and the computer vision algorithms of the present disclosure. In a sequence sorting task, the level of difficulty can be balanced and managed to ensure the CNN works as desired. Sampling tuples from static regions can, in some cases, be difficult for the system to sort the shuffled sequence. Alternatively, portions of a video or image which allow the system to pick up low-level cues to achieve the task can be too easy and may not result in the desired feature identification. Accordingly, the processing steps 14 ensure the data that is given to the CNN properly trains the CNN to handle computer vision tasks.

In step 16, sample candidate frames from unlabeled input video are chosen based on motion magnitude. Motion-aware tuple selection can use the magnitude of optical flow to select frames with large motion regions. In addition to using optical flow magnitude for frame selection, the system of the present disclosure can further select patches with large motion. Specifically, for video frames in the range [tₘᵢₙ, tₘₐₓ], can use sliding windows to mine frame tuple {tₐ, t_{b}, t_{c}, t_{d}} with large motion. The system can also use a sliding windows approach on the optical flow fields to extract patches tuple with large motion magnitude.

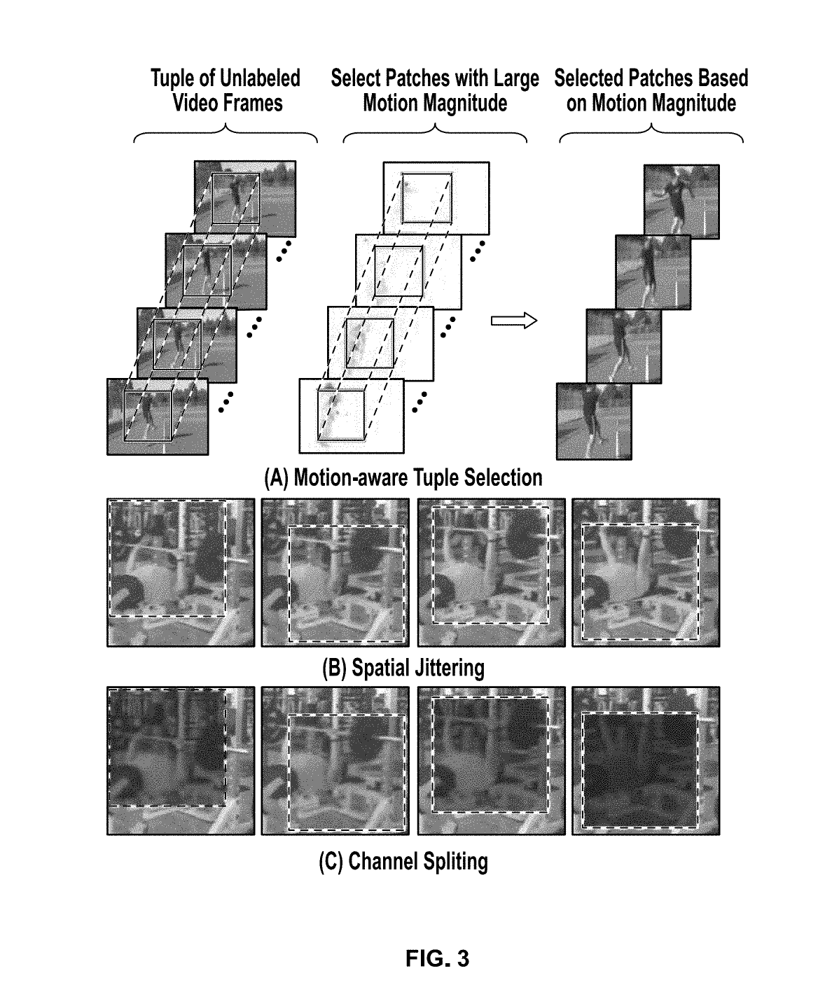

FIG. 3 is a drawing illustrating a data sampling process carried out by the sytem on a sample video. As can be seen in section (a) of FIG. 3, a tuple of unlabeled video frames are received and the system can select patches with large motion magnitude. In this example, the patch that is selected is the portion with the tennis player depicted in the images. Some portions of the background can be outside of the patch as there is a smaller motion magnitude in those portions. Accordingly, the output patches include the tennis player as can be seen in section (a) of FIG. 3.

Turning back to FIG. 2, in step 18, the system of the present disclosure applies spatial jittering and channel splitting on the selected patches in step 16. As the previously-selected tuples are extracted from the same spatial location, simple frame alignment could be used to sort the sequence. As can be seen section (b) of FIG. 3, spatial jittering can be applied within a tuple to prevent the system of the present disclosure from extracting low-level features. Also to avoid the system from learning low-level features without semantic understanding, channel splitting can be applied on the selected patches, as shown part (c) of FIG. 3. For each frame in a tuple, the system can randomly choose one channel and duplicate the values to other two channels.

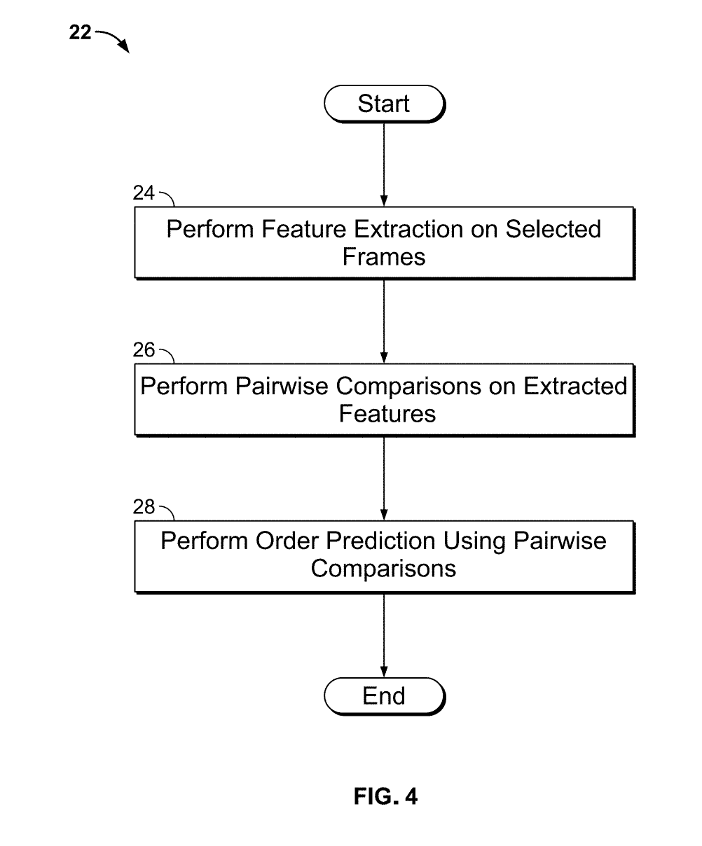

FIG. 4 is a flowchart illustrating processing steps (identified generally at 22) according to the system of the present disclosure for predicting the order of a randomly-shuffled video tuple. Once the data is sampled as explained above, the system can randomly shuffle the video and require the CNN to order the frames in the correct sequential order. In step 24, the system 24 performs feature extraction on selected features of a video tuple. Then, in step 26, the system performs pairwise comparisons on the extracted features. In step 28, the system performs order prediction using pairwise comparisons. The system can first compute all the pairwise comparisons and fuse them for order prediction.

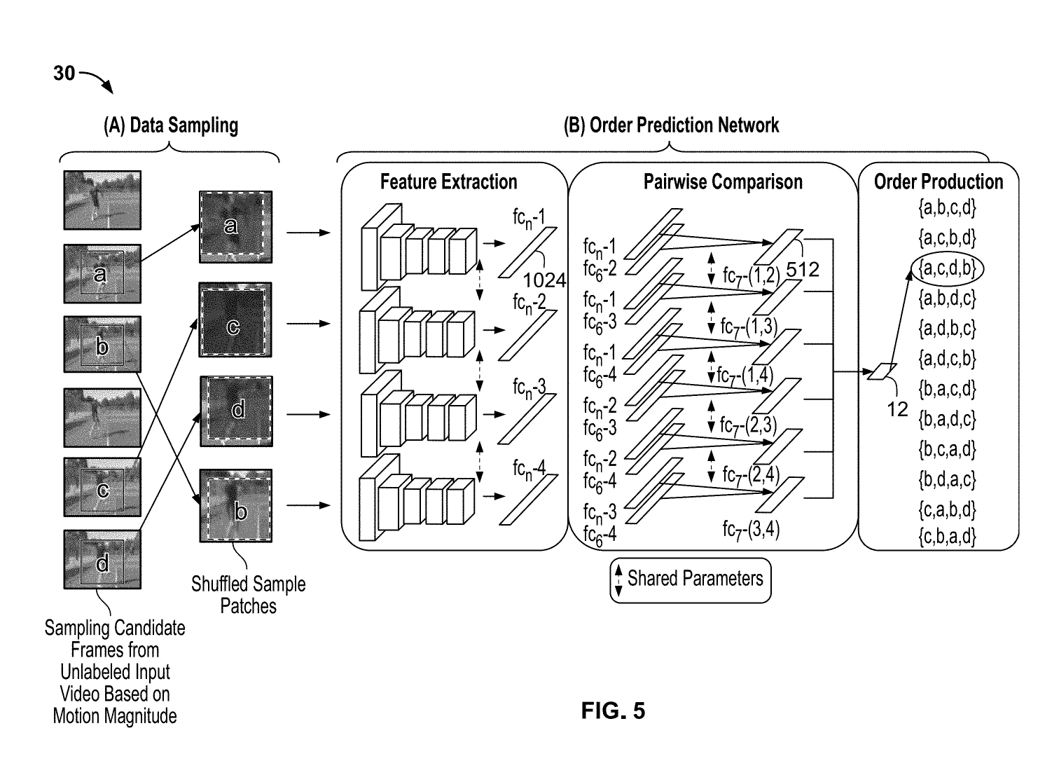

FIG. 5 is a block diagram illustrating the overall architecture of the system of the present disclosure. As can be seen in portion (a), data sampling can be performed first as discussed in greater detail above. After data sampling, feature extraction can be done as noted above. In particular, features for each frame (fc6) can be encoded by convolutional layers. A siamese architecture can be used where all the branches can share the same parameters. After feature extraction, pairwise comparison can occur. The system can concatenate either fc6 or fc7 features for the frames, and use the concatenation as the representation of the input tuple. Alternatively, pairwise comparisons can be performed on extracted features by taking the fc6 features from every pair of frames for local comparisons. For example, as can be seen in FIG. 5, the layer 7-(1,2) can output the relationship of the first and second frames, layer 7-(2, 3) the first and third frames, and layer 7-(3,4) the third and fourth frames. The final order prediction can then based on the concatenation of all local comparisons after one fully connected layer and softmax function.

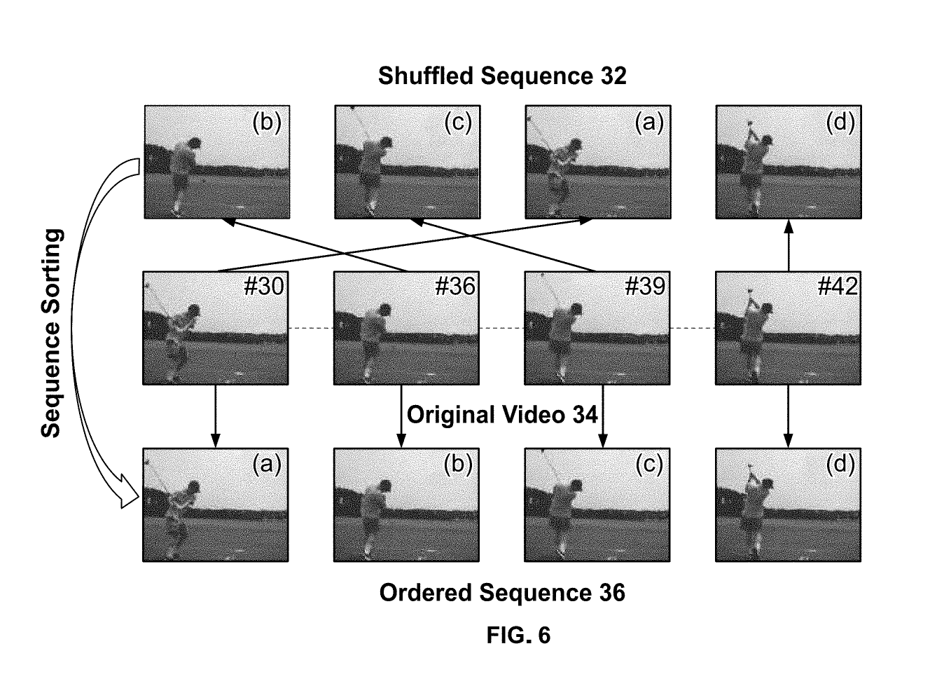

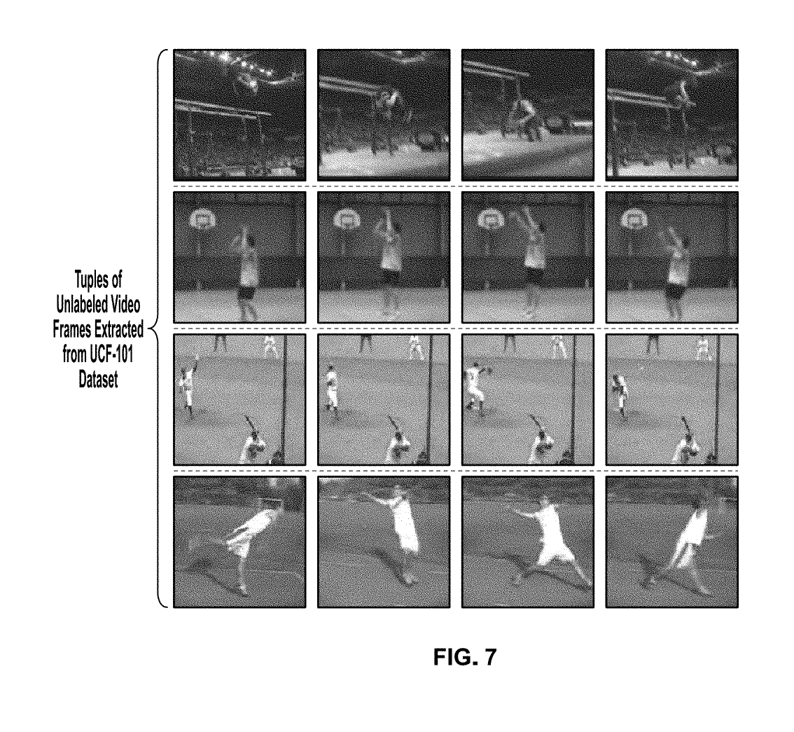

FIG. 6 depicts images illustrating a video tuple as being processed by the system of the present disclosure. As can be seen, an original video is sampled by the data sampling routine as described above. Spatial jittering and channel splitting can be performed as described above. The frames can also be randomly shuffled so that the system of the present disclosure can order the sequence and learn identified visual elements in the video, enhancing the computer vision capabilities of the CNN. Feature extraction can be performed on the tuple. Pairwise comparison and order prediction can then be done to order the sequence as shown in FIG. 6. This process allows the CNN to learn about the features shown in the video to allow the CNN to detect similar features in other videos or images such as a golfer, golf club, etc. Similarly, FIG. 7 depicts other examples of randomly shuffled tuples that the system can detect in accordance with the process described above.

The system of the present disclosure can be implemented in the Caffe toolbox. In particular, CaffeNet can be used to implement the convolutional layers of the CNN, and is a slight modification of AlexNet. The network of the present disclosure can take 80×80 patches as inputs. This can reduce the number of parameters and training time. This implementation depends on only 5.8M parameters up to fc7. The system can use stochastic gradient descent with a momentum of 0.9 and a dropout rate of 0.5 on fully connected layers. The system can also use batch normalization on all layers. The system can extract 280 k tuples from the UCF-101 dataset as the training data. To train the CNN, the batch size can be set as 128, and the basic learning rate as 10-2. The system can reduce the learning rate by a factor of 10 at 130 k and 350 k iterations, with a total of 200 k iterations. The total training process can take about 40 hours on one Titan X GPU. Other GPUs can be used within the spirit of the present disclosure.

The system of the present disclosure also provides an experimental approach for determining the accuracy of the computer vision recognition system. The split 1 of the UCF-101 and HMDB-51 action recognition benchmark datasets can be used to evaluate the performance of the unsupervised pre-trained CNN. The UCF-101 dataset include 101 action categories with about 9.5 k videos for training and 3.5 k videos for testing. The HMDB-51 dataset consists of 51 action categories with about 3.4 k videos for training and 1.4k videos for testing. Tables 1 and 2 below show the results of the system of the present disclosure against other systems.

TABLE 1

| Initialization | CaffeNet | VGG-M-2048 |
|---|---|---|
| random | 47.8 | 51.1 |
| ImageNet | 67.7 | 70.8 |
| Misra et al. [24] | 50.9 | — |
| Purushwalkam et al. [30]* | — | 55.4 |
| Vondrick et al. [39]† | 52.1 | — |
| binary | 52.6 | 57.7 |
| 3-tuple Concat | 53.4 | 59.2 |
| 3-tuple OPN | 54.1 | 57.8 |
| 4-tuple Concat | 56.1 | 59.5 |
| 4-tuple OPN | 57.3 | 60.5 |

TABLE 2

| Initialization | CaffeNet | VGG-M-2048 |
|---|---|---|
| random | 17.6 | 19.3 |
| Imagenet | 28.5 | 36.1 |
| Misra et al. [24] | 19.8 | — |
| Purushwalkam et al. [30]* | — | 23.6 |
| 4-tuple OPN | 21.6 | 22.8 |
| Misra et al. [24] (UCF) | 15.2 | — |
| 4-tuple OPN (UCF) | 22.8 | 24.8 |

As can be seen above, the quantitative results imply that more difficult tasks provide stronger semantic supervisory signals and guide the network to learn more meaningful features. The system of the present disclosure obtains 57.3% accuracy compared to 52.1% of from Vondrick et al. on the UCF-101 dataset. To compare with Purushwalkam et al., the CNN of the present disclosure can also be trained using VGG-M-2048. Note that Purushwalkam et al. uses the UCF-101, HMDB-51 and ACT datasets to train their model (about 20 k videos). In contrast, the system of the present disclosure uses videos from the UCF-101 training set and outperforms Purushwalkam et al. by 5.1%.

The system of the present disclosure can also be compared with a O3N system. To account for the use of stacks of frame differences (15 channels) as inputs rather than RGB images, the system of the present disclosure can take single frame difference Diff(t)=RGB(t+1)−RGB(t) as inputs to train our model. The system can initialize the network with models trained on RGB and Diff features. As shown in Table 3 below, the system of the present disclosure compares favorably against O3N by more than 10% gain on the UCF-101 dataset and 5% on the HMDB-51 dataset. The performance of initializing with the model trained on RGB features is similar to with the CNN trained on frame difference. The results demonstrate the generalizability of the present disclosure.

TABLE 3

| Method | unsupervised | supervised | UCF | HMDB |
|---|---|---|---|---|
| O3N[8] | Stack of Diff | Stack of Diff | 60.3 | 32.5 |
| OPN | RGB | Diff | 71.8 | 36.7 |
| OPN | Diff | Diff | 71.4 | 37.5 |

The system of the present disclosure can also be evaluated for transferability of learned features. The system can initialize the weights with the model trained on the UCF-101 training set (without using any labels). Table 2 above shows the results where the present system achieves 22.5% compared to 15.2% of another system under the same setting. The present system achieves slightly higher performance when there is no domain gap (i.e., using training videos from the HMDB-51 dataset). The results suggest that the present system method is not heavily data dependent and is capable of learning generalizable representations.

To evaluate the generalization ability of the present system, the system can be used as pre-trained weights for classification and detection tasks. The PASCAL VOC 2007 dataset has 20 object classes and contains 5,011 images for training and 4,952 images for testing. For both tasks, a fine-tuning strategy known in the art can be used without a rescaling method. The CaffeNet architecture can be used, and the Fast-RCNN pipeline for the detection task can also be employed. The system can use the mean average precision (mAP). Since the present system has fully connected layers that can be different from a standard CNN, the weights of the convolutional layers can be copied and initialized the fully connected layers from a Gaussian distribution with mean 0 and standard deviation 0.005. Table 4 below lists the summary of methods using static images and method using videos.

TABLE 4
Results of the Pascal VOC2007 classification and detection datasets.

| Method | Pretraining time | Source | Supervision | Classification | Detection |
|---|---|---|---|---|---|
| Krizhevsky et al. [17] | 3 days | ImageNet | labeled classes | 78.2 | 56.8 |
| Doerch et al. [6] | 4 weeks | ImageNet | context | 55.3 | 46.6 |
| Pathak et al. [29] | 14 hours | ImageNet + StreetView | context | 56.5 | 44.5 |
| Norrozi et al. [26] | 2.5 days | ImageNet | context | 68.6 | 51.8 |
| Zhang et al. [42] | — | ImageNet | reconstruction | 67.1 | 46.7 |
| Wang and Gupta (color) [40] | 1 weeks | 100k videos, VOC2012 | motion | 58.4 | 44.0 |
| Wang and Gupta (grayscale) [40] | 1 weeks | 100k videos, VOC2012 | motion | 62.8 | 47.4 |
| Agrawal et al. [2] | — | KITTI, SF | motion | 52.9 | 41.8 |
| Misra et al. [24] | — | <10k videos | motion | 54.3 | 39.9 |
| Ours (OPN) | <2 days | <10k videos | motion | 60.3 | 44.8 |

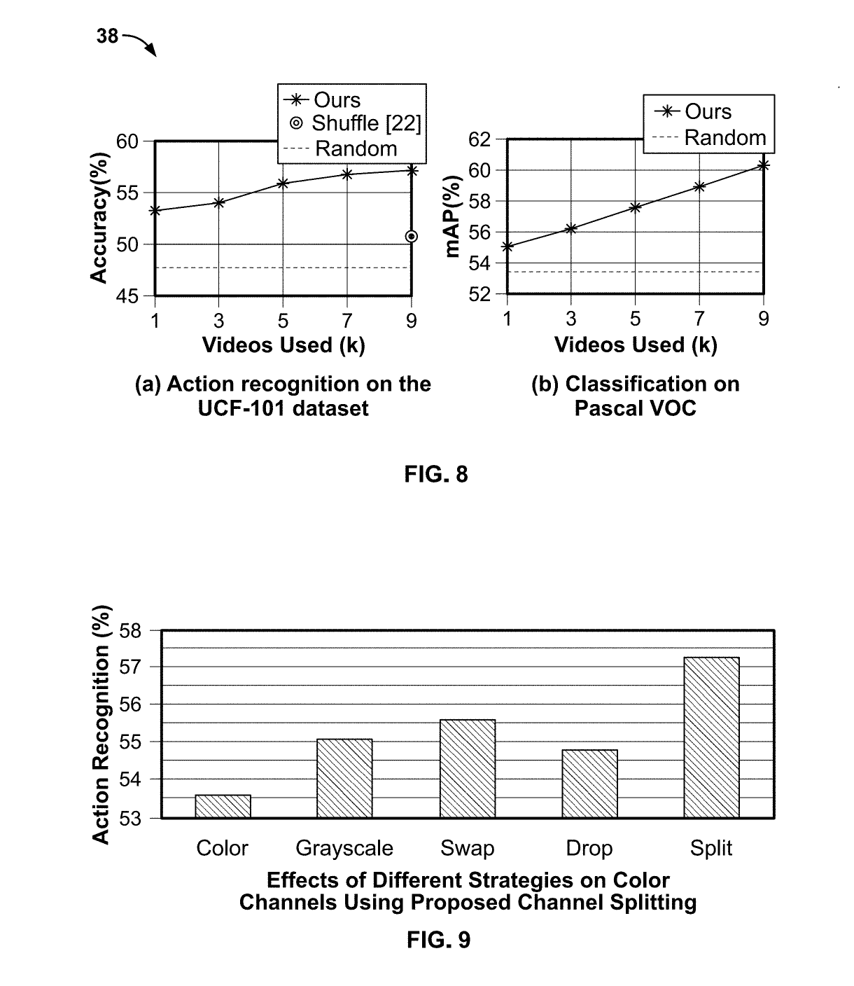

FIG. 8 depicts graphs illustrating the performance of training a convolutional neural network with two different datasets. In particular, FIG. 8 is a graph comparison showing that the system of the present disclosure performs well when being trained with more videos. FIG. 8 shows the results on the UCF-101 and the Pascal VOC 2007 datasets. On the UCF-101 dataset, the system of the present disclosure can outperforms other systems using only lk videos for pre-training. For the classification task on the Pascal VOC 2007 dataset, the performance consistently improves with the number of training videos. Training with large-scale and diverse videos can also further provide greater performance.

The system of the present disclosure can also perform ablation analysis. First, unsupervised pre-training can be performed using the videos from the training set. The learned weights are then used as the initialization for the supervised action recognition problem. The training tuples can be selected according to the magnitude of optical flow. The optical flow direction can also be used as a further restriction. Specifically, the motion in the selected interval must remain in the same direction. Table 5 below shows the results of how these tuple selection methods affect the final performance. Random selection degrades the performance because the training data contain many similar patches that are difficult to be sorted (e.g., static regions). Direction constraints can also be eliminated to improve performance because it oversimplifies the task. In particular, direction constraints eliminates many tuples with shape deformation (e.g., pitching contains motions in reverse direction). The CNN thus is unable to learn meaningful high-level features.

TABLE 5

| Strategy | Action Recognition (%) |
|---|---|
| Random | 47.2 |
| Motion | 57.3 |
| Motion + Direction | 52.6 |

Different patch sizes can also be used for training the CNN. Due to the structure of fully connected layers, the patch size selection can affects the number of parameters and thus the training time. Table 6 below shows the comparison among using patch size 80×80, 120×120, and the entire image. It shows that using 80×80 patches has an advantage in terms of the number of parameters, training time, and most importantly, the performance. One potential reason for lesser performance of using larger patches can be the insufficient amount of video training data.

TABLE 6
Comparison of using different patch sizes. Using
80 × 80 patches has advantages in all aspects.

| Patch | | | Action |
|---|---|---|---|
| size | #Parameters | Traming time | Recognition (%) |
| 80 | 5.8M | 1x | 57.3 |
| 120 | 7.1M | 1.4x | 55.4 |
| 224 | 14.2M | 2.2x | 51.9 |

Spatial jittering can be applied to frames in a tuple to avoid the CNN from learning low-level statistics as noted above. Table 7 shows the results that spatial jittering helps the CNN learn better features.

TABLE 7
Effect of spatial jittering. For both 3-tuple and 4-
tuple cases, OPNs with spatial uittering perform better.

| Method | Spatial uittering | Action Recognition (%) |
|---|---|---|
| 3-tuple OPN | | 53.8 |
| 3-tuple OPN | V | 54.1 |
| 4-tuple OPN | | 56.5 |
| 4-tuple OPN | V | 57.3 |

FIG. 9 is a graph showing the results of the system employing different strategies for reducing visual clues from color. As noted above, to further prevent the CNN from learning trivial features, the system uses channel splitting. In particular, the system tries to reduce the visual clues from color. One possible method is to use the grayscale image. Alternatively, to mitigate the effect of color, the system can randomly choose one representative channel for every frame in a tuple, called channel splitting (Split). Still further, the system can use (1) Swap which randomly swaps two channels or (2) Drop which randomly drops one or two channels.

The system can also show the effect of the pair-wise comparison stage as well as the performance correlation between the sequence sorting task and action recognition. The order prediction task can be evaluated on a held-out validation set from the automatically sampled data. Table 8 shows the results. For both 3-tuple and 4-tuple, models with the pairwise comparison perform better then models with simple concatenation on both order prediction and action recognition tasks. The improvement of the pairwise comparison over concatenation is larger on 4-tuple than on 3-tuple due to the difficulty of the order prediction task.

TABLE 8
Effect of pairwise comparison on order prediction
and action recognition. The results demonstrate the
performance correlation between two tasks, and show that
OPN facilitates the feature learning.

| | Order | Action |
|---|---|---|
| Method | Prediction (%) | Recognition (%) |
| 3-tuple Concat | 59 | 53.4 |
| 3-tuple OPN | 63 | 54.1 |
| 4-tuple Concat | 38 | 56.1 |
| 4-tuple OPN | 41 | 57.3 |

The quality of the learned features can be demonstrated by visualizing low-level first layer filter (conv1) as well as high-level activations (pool5).

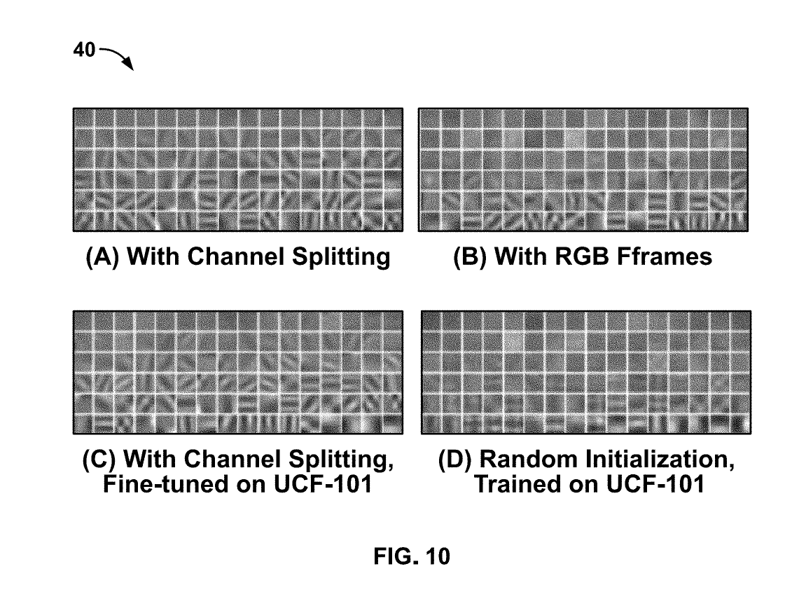

FIG. 10 depicts image illustrating visualization by the system of the present disclosure of the learned filters in conv1. FIGS. 10(a) and (b) show that although using all color channels enable the network to learn some color filters, there can be many “color patch” filters (see the first two rows in FIG. 10(b)). These filters can lack generalizability and can easily make further fine-tuning stuck at a bad initialization. Comparing FIGS. 10(c) and (d), the filters are sharper and of more varieties when initialized by our method.

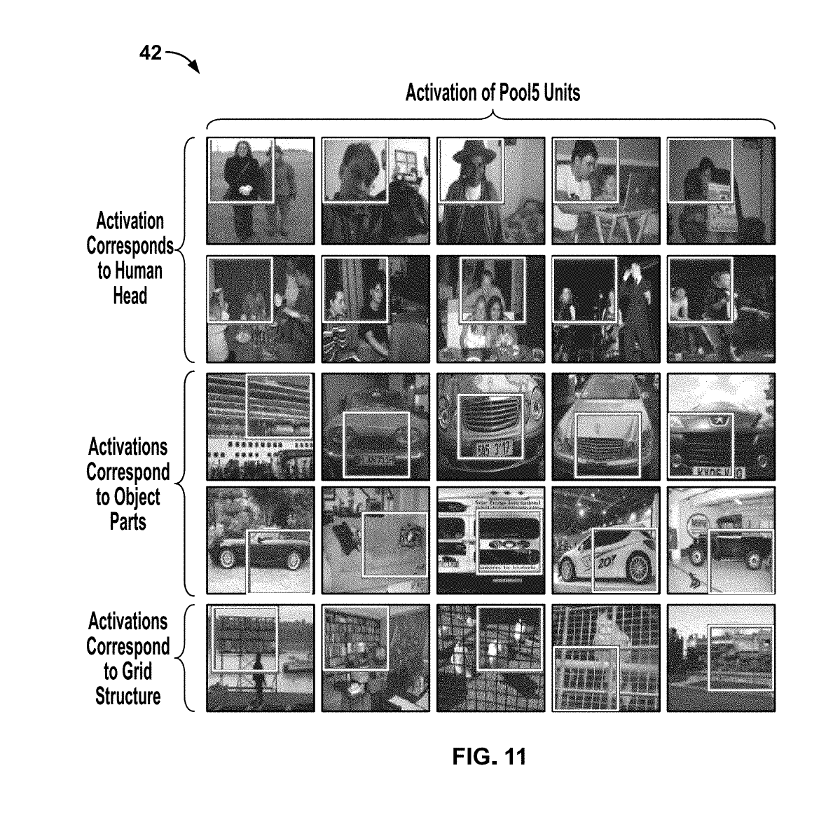

FIG. 11 depicts images illustrating the top 5 activations of several pool5 units on the Pascal VOC 2007 dataset. Although the system can be trained on the UCF-101 dataset which focuses on action classes, it can capture some meaningful regions without fine-tuning. For example, the first two rows are human-related, the first unit captures a single person, while the second unit capture two people side by side. Units from the second to fifth rows capture the front of cars, wheel-like object, and grid structure, respectively.

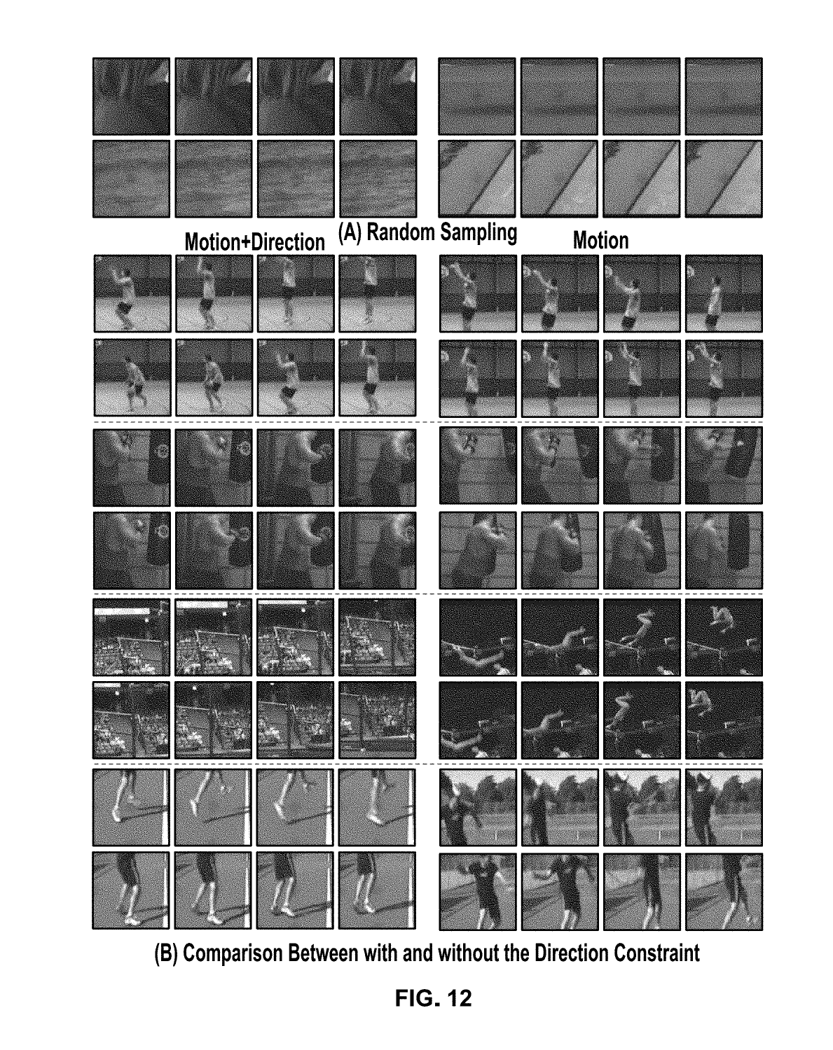

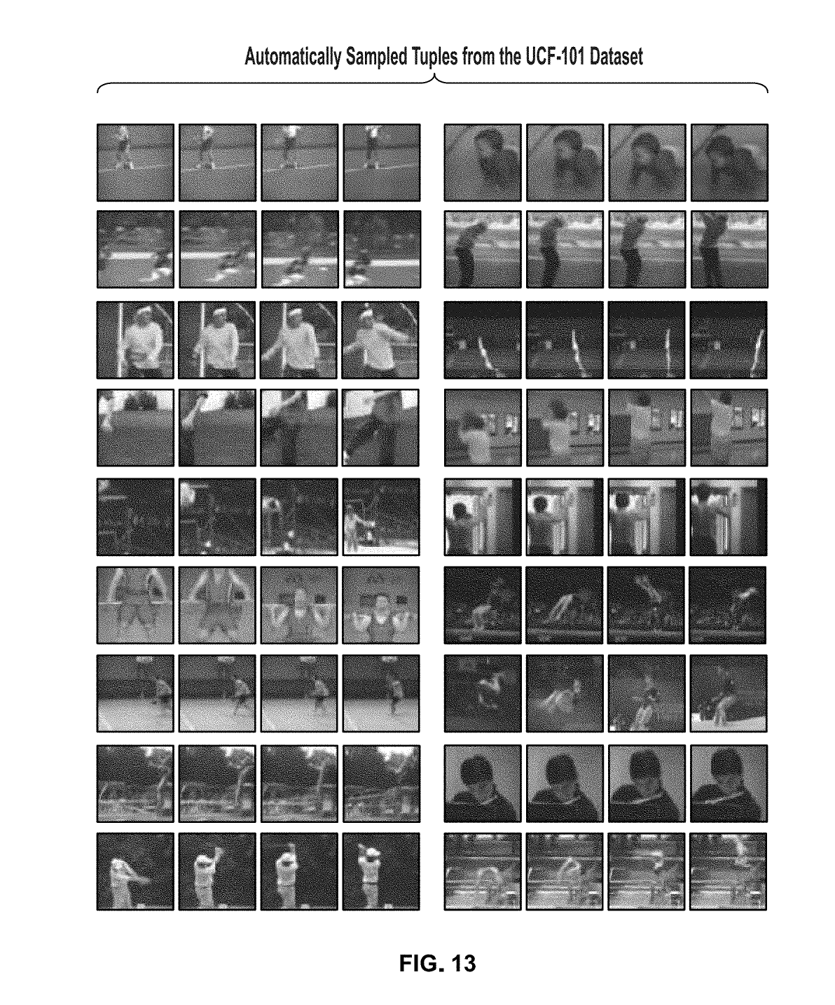

FIGS. 12 and 13 depict images illustrating different approaches to data sampling that can be carried out by the system of the present disclosure. One approach is random sampling in which the system can randomly select non-repetitive frames and randomly crop selected frames at the same location. For example, portion (a) of FIG. 12 shows several examples of random sampling strategy. Randomly sampling patches can produce visually similar tuples that are difficult to sort. The patches could correspond to a static region in the scene as shown in the first two rows of portion (a) of FIG. 12. Even if there are distinguishable differences among frames, the differences may not be semantically meaningful (e.g., the lower left tuple: dynamic textures; the lower right tuple: camera motion). In portion (b) of FIG. 12, the example tuples of using motion can be compared with and without the direction constraint. The tuples in each two rows in portion (b) of FIG. 12 can be sampled from the same video. Although two strategies could generate similar tuples in some videos, e.g., the first and second videos, the direction constraint could fail to capture complicated human motion in many cases. For examples, in the third video, the direction constraint can eliminate the tuples involved the gymnastics movement. In the fourth video, the direction constraint can fail to extract the swing movement. Accordingly, motion without the direction constraint can be used. FIG. 13 shows additional examples of the automatically extracted tuples from the UCF-101 dataset.

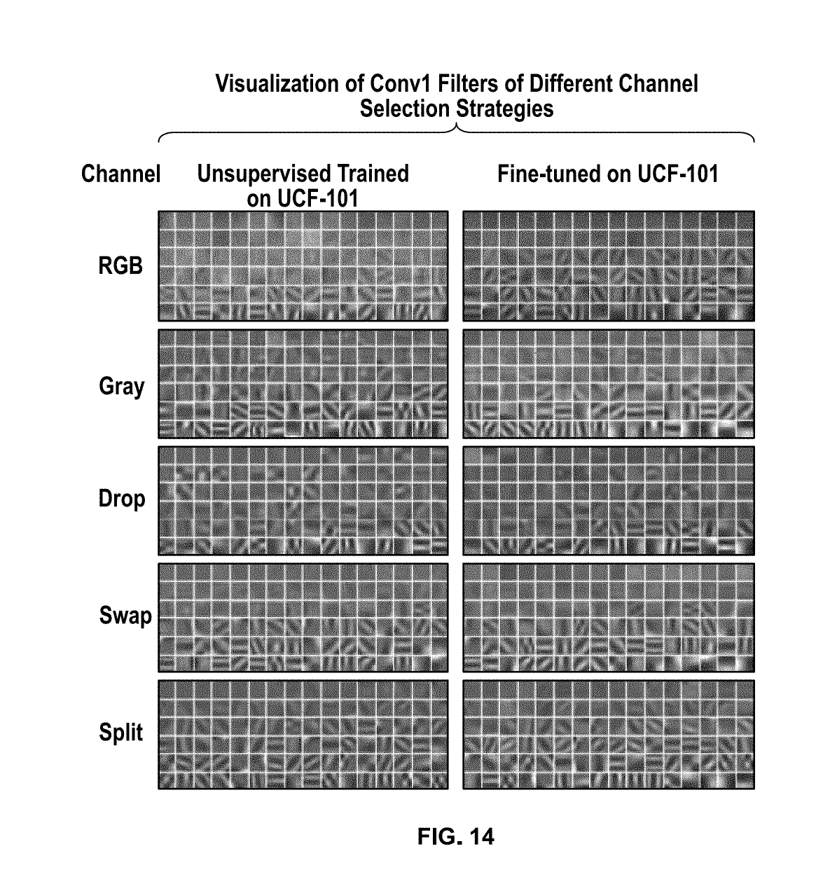

FIG. 14 depicts images illustrating results of various channel selection methods before and after fine tuning. Some methods of channel selection, include but are not limited to, red/green/blue (RGB), Gray, Split, Drop, and Swap. In Table 9, the quantitative evaluation is shown on the UCF-101 dataset of the five channel selection methods.

TABLE 9

| | | Action |
|---|---|---|
| Method | Description | Recognition (%) |
| RGB | Original three color channels. | 53.7 |
| Gray | Grayscale images | 55.1 |
| Split | Randomly select one representative | 57.3 |
| | channel for every frame in a tuple. | |
| Drop | Randomly drop one or two | 54.8 |
| | channels for every frame in a tuple. | |
| Swap | Randomly swap two channels | 55.6 |
| | for every frame in a tuple. | |

In FIG. 14, the convl filters of each method can be seen before and after fine-tuning. The results show that using the proposed channel splitting method can help learn edge-like filters that capture the low-level image structures (e.g., edges, corner) and are invariant to photometric appearance variations. On the other hand, the filters learned from RGB frames (the first row) can produce several filters that correspond to particular color patches. These filters can result in poor initialization and cannot be recovered even after fine-tuning on the UCF-101 dataset (see the right-hand side in the first row).

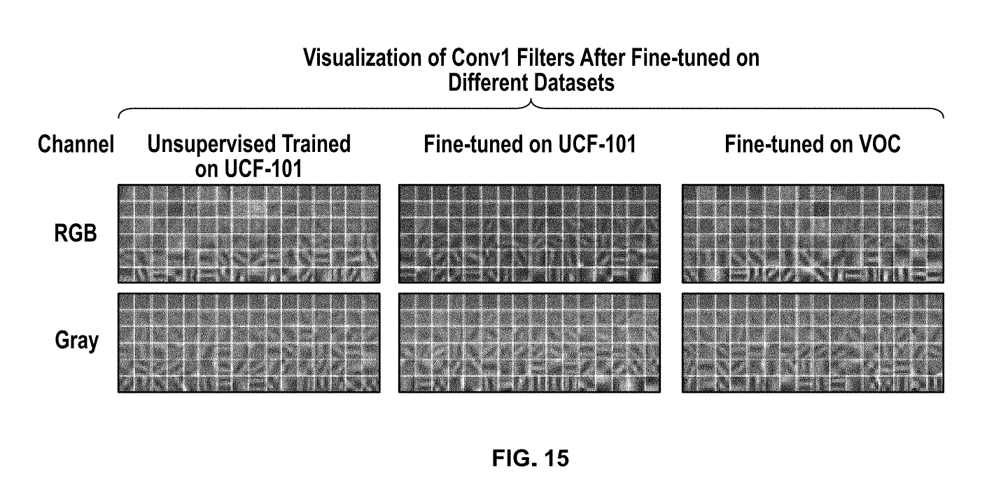

FIG. 15 depicts comparison the convl filters of RGB and Split after fine-tuning on the UCF-101 and the VOC dataset. After fine-tuned on the VOC dataset, the Split model can adapt to the new dataset. The RGB model, however, still could contain filters that only respond to particular color regions in the image.

The present disclosure is not limited to the 3-tuple and 4-tuple video frames, but rather 5-tuple OPN can be used. For 5-tuple input, the system can take a tuple of 5 frames as the input and the CNN can predicts 5!/2 =60 classes. Table 10 below shows the results of the 5-tuple OPN on the action recognition, classification, and detection.

TABLE 10

| | Action | Classification | Detection |
|---|---|---|---|
| Initialization | Recognition (%) | (%) | (%) |
| 3-tuple OPN | 54.1 | 55.3 | 42.0 |
| 4-tuple OPN | 57.3 | 60.3 | 44.8 |
| 5-tuple OPN | 56.1 | 59.2 | 44.1 |

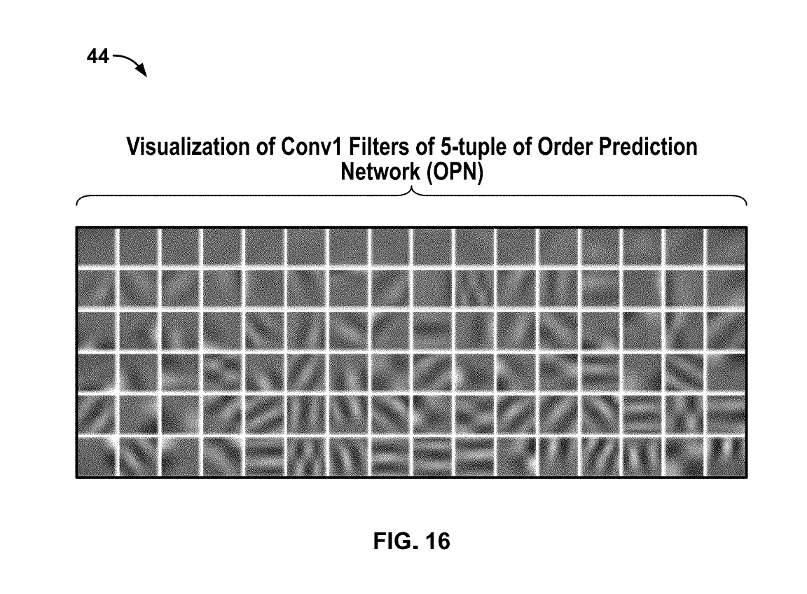

FIG. 16 depicts the convl filters of the 5-tuple OPN. While the performance of 5-tuple OPN is can in some cases be slightly worse than that of the 4-tuple OPN, this does not suggest weaker supervisory signals from sorting 5-tuple sequence. The number of classes of 5-tuple input is significantly larger than that of 4-tuple input (i.e., 60 vs. 12). A 5-tuple input inherently requires more training data yet the number of extracted tuples can be limited.

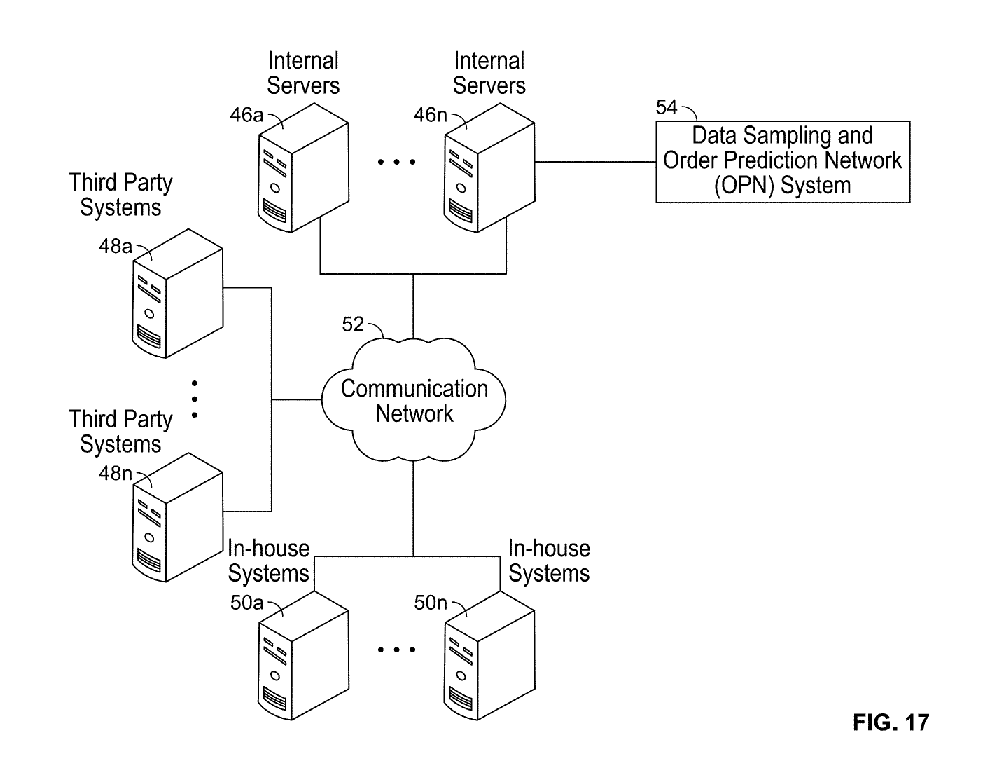

FIG. 17 is a diagram illustrating computer hardware and network components on which the system of the present disclosure could be implemented. The system can include a plurality of internal servers 46a-46n having at least one processor and memory for executing the computer instructions and methods described above (which could be embodied as computer software 54 illustrated in the diagram). The system can also include a plurality of third party systems 48a-48n for receiving the sample video data or image data. The system can also include a plurality of in-house systems 50a-50n for hosting testing video data. These systems can communicate over a communication network 52. The data sampling and order prediction system or engine can be stored on the internal servers 46a-46n, or an external server.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is intended to be protected by Letters Patent is set forth in the following claims.

1. A method for unsupervised representation learning by sorting sequences, comprising:
receiving at a computer system unlabeled input video from a source;
sampling candidate frames from the unlabeled input video at the computer system to generate a video tuple; and
training a convolutional neural network (“CNN”) using the computer system to sort the frames in the video tuple into chronological order.

2. The method of claim 1, wherein the source is one of a video recording system, a data source, the Internet, or a cloud-based video source.

3. The method of claim 1, wherein the candidate frames comprise four randomly shuffled frames.

4. The method of claim 1, wherein step of sampling candidate frames from the unlabeled input video comprises:
selecting one or more patches from the candidate frames based on motion magnitude;
applying spatial jittering and channel splitting on the one or more patches; and
randomly shuffling the one or more patches.

5. The method of claim 4, wherein step of sampling candidate frames comprises motion-aware tuple selection using a magnitude of optical flow to select frames with large motion.

6. The method of claim 5, wherein the step of sampling candidate frames further comprises a sliding windows approach.

7. The method of claim 4, wherein the one or more patches can be a portion of the frame or the entire frame.

8. The method of claim 4, wherein channel splitting comprises randomly selecting a channel and duplicating values of the channel to two further channels.

9. The method of claim 1, wherein step of training the CNN comprises:
performing a feature extraction on selected features of the video tuple to generate extracted features;
performing pairwise comparisons on the extracted features; and
performing an order prediction using the pairwise comparisons.

10. The method of claim 9, further comprising computing the pairwise comparisons and fusing the pairwise comparisons for order prediction.

11. A system for unsupervised representation learning by sorting sequences, comprising:
a processor in communication with a source; and
computer system code executed by the processor, the computer system code causing the processor to:
receive unlabeled input video from the source;
sample candidate frames from the unlabeled input video to generate a video tuple; and
train a convolutional neural network (“CNN”) to sort the frames in the video tuple into chronological order.

12. The system of claim 11, wherein the source is one of a video recording system, a data source, the Internet, or a cloud-based video source.

13. The system of claim 11, wherein the candidate frames comprise four randomly shuffled frames.

14. The system of claim 11, wherein during step of sample candidate frames from the unlabeled input video, the computer system code causes the processor to:
select one or more patches from the candidate frames based on motion magnitude;
apply spatial jittering and channel splitting on the one or more patches; and
randomly shuffle the one or more patches.

15. The system of claim 14, wherein step of sample candidate frames comprises motion-aware tuple selection using a magnitude of optical flow to select frames with large motion.

16. The system of claim 15, wherein the step of sample candidate frames further comprises a sliding windows approach.

17. The system of claim 14, wherein the one or more patches can be a portion of the frame or the entire frame.

18. The system of claim 14, wherein channel splitting comprises randomly selecting a channel and duplicating values of the channel to two further channels.

19. The system of claim 11, wherein during step of training the CNN, the computer system code causes the processor to:
perform a feature extraction on selected features of the video tuple to generate extracted features;
perform pairwise comparisons on the extracted features; and
perform an order prediction using the pairwise comparisons.

20. The system of claim 19, wherein the computer system code further causes the processor to compute the pairwise comparisons and fuse the pairwise comparisons for order prediction.
